(19) United States
(12) Patent Application Publication
(10) Pub. No.: US 2003/0192656 A1
(43) Pub. Date: Oct. 16, 2003

(54) Control apparatus for controlling tilting of a plurality of horizontally disposed mini-blind slats

(76) Inventor: Steve Burgess, Madison, WI (US)

Correspondence Address: DAVID J. ARCHER, 9790 FOREST PRESERVE RD, DURAND, IL, 61024, US

(21) Appl. No.: 10/119,595

(22) Filed: Apr. 10, 2002

(51) Int. Cl. E06B 9/26

(52) U.S. Cl. 160/176.1 R

(57) ABSTRACT

A control apparatus is disclosed for controlling tilting of a plurality of horizontally disposed mini-blind slats. The apparatus includes a support frame for supporting the plurality of slats such that the slats are disposed spaced and parallel relative to each other. A tilting mechanism is pivotally secured to the frame about a pivotal axis which extends spaced and parallel relative to the slats. A first anchor is secured to the tilting mechanism and a second anchor is secured to the tilting mechanism such that the pivotal axis of the tilting mechanism is disposed between the first and second anchors. A first control has a first and a second end, the first end of the first control being secured to the first anchor. A second control has a first and a second extremity, the first extremity of the second control being secured to the second anchor. The first and second controls are connected to the slats such that relative movement between the first and second control tilts the slats between an open and a closed disposition thereof. A device is drivingly connected to the tilting mechanism for pivoting the tilting mechanism about the pivotal axis so that the slats are tilted between the open and closed dispositions.

### BACKGROUND OF THE INVENTION

1. Field of the Invention

The present invention relates to a control apparatus for controlling tilting of mini-blind slats. More specifically, the present invention relates to a control apparatus for controlling tilting of a plurality of horizontally disposed mini-blind slats.

2. Background Information

Mini-blinds usually incorporate relatively complex mechanisms for altering the angle of tilt of the respective horizontal slats. Many prior art mini-blinds employ ladder arrangements for supporting the slats so that the slats rest on and are supported by the rungs of the ladder. When the front and rear cords of the ladder are moved relative to each other, the slats are correspondingly tilted between an open and closed disposition. Various mechanisms are used for moving the front and rear cords of the ladder and these mechanisms are relatively complex and the manufacture of the same is labor intensive. Additionally, a mechanism is required in order to lift and lower the slats and relatively complicated arrangements have been provided in order to avoid any interference between the operation of the tilting and the lifting mechanisms.

The present invention provides a unique and relatively simple mechanism for combining the tilting and lifting functions of a mini blind.

Therefore, it is a primary feature of the present invention to provide a control apparatus for controlling tilting of a plurality of horizontally disposed mini-blind slats that overcomes the problems associated with the prior art arrangements.

Another feature of the present invention is the provision of a control apparatus for controlling tilting of a plurality of horizontally disposed mini-blind slats that is relatively easy to manufacture.

A further feature of the present invention is the provision of a control apparatus for controlling tilting of a plurality of horizontally disposed mini-blind slats that is of relatively low cost.

Other features and advantages of the present invention will be readily apparent to those skilled in the art by a consideration of the detailed description of a preferred embodiment of the present invention contained herein.

### SUMMARY OF THE INVENTION

The present invention relates to a control apparatus for controlling tilting of a plurality of horizontally disposed mini-blind slats. The apparatus includes a support frame for supporting the plurality of slats such that the slats are disposed spaced and parallel relative to each other. A tilting mechanism is pivotally secured to the frame about a pivotal axis which extends spaced and parallel relative to the slats. A first anchor is secured to the tilting mechanism and a second anchor is secured to the tilting mechanism such that the pivotal axis of the tilting mechanism is disposed between the first and second anchors. A first control has a first and a second end, the first end of the first control being secured to the first anchor. A second control has a first and a second extremity, the first extremity of the second control being secured to the second anchor. The first and second controls are connected to the slats such that relative movement between the first and second control tilts the slats between an open and a closed disposition thereof. A device is drivingly connected to the tilting mechanism for pivoting the tilting mechanism about the pivotal axis so that the slats are tilted between the open and closed dispositions.

In a more specific embodiment of the present invention, the support frame is of inverted U-shaped cross-sectional configuration, the frame having a first and a second side.

Moreover, the tilting mechanism includes an axle having a first and a second termination, the axle being rotatable about the pivotal axis. Also, the axle is secured to and disposed within the frame such that pivoting of the tilting mechanism about the pivotal axis is permitted.

Additionally, the tilting mechanism includes a first and a second wheel, the wheels being congruent and spaced relative to each other.

Furthermore, the first wheel defines a plurality of teeth which extend around at least a portion of a periphery of the first wheel Also, the second wheel defines a further plurality of teeth which extend around at least a portion of a periphery of the second wheel so that when at least one of the wheels is driven via the teeth, the tilting mechanism is pivoted about the pivotal axis.

More specifically, the first anchor defines a slot for anchoring the first end of the first control and the second anchor defines a further slot for anchoring the first extremity of the second control, the anchors being secured to and extending between the first and second wheels.

The first control is a polyester tape and the second control is also a polyester tape.

More particularly, the polyester tapes are of rectangular cross sectional configuration and are fabricated from a translucent material.

The first control is connected to the slats between the first and second ends of the first control and the second control is connected to the slats between the first and second extremities of the second control.

Additionally, the device drivingly intermeshes with the plurality of teeth and the further plurality of teeth so that when the device is rotated, the wheels are pivoted about the pivotal axis.

The apparatus also includes a spool which is rotatably secured to the frame such that the tilting mechanism is disposed between the spool and the slats.

A further control has a first and a second termination, the first termination being anchored to the spool so that when the spool is rotated, the further control is wound around the spool.

The second termination of the further control is secured to a lowermost slat of the plurality of slats, the further control being slidably connected to the slats disposed between the lowermost slat and the tilting mechanism. The arrangement is such that the further control extends between the wheels of the tilting mechanism so that when the spool is rotated, the lowermost slat is lifted into lifting engagement with the slats disposed between the lowermost slat and the tilting mechanism such that the slats are raised towards the frame.

Furthermore, a shaft is rotatably secured to the frame, the shaft being secured to the spool such that when the shaft is rotated about a further pivotal axis, the spool is rotated for winding and unwinding the further control.

A driving drum is secured to the shaft and spaced axially relative to the spool. Also, a flexible drive has a first and a second end, the first end of the flexible drive being anchored to the driving drum such that when the second end of the flexible drive is pulled, the flexible drive is unwound from the driving drum so that the driving drum is rotated for rotating the spool for lifting the slats.

Additionally, a locking mechanism is provided for locking the flexible drive so that the lowermost slat is able to be selectively located relative to the frame.

A weight is secured to at least one of the slats for assisting lowering the lowermost slat away from the frame when the locking mechanism is disengaged from the flexible drive.

Moreover, the apparatus further includes a valance which is slidably disposed relative to the frame. The valance slides from a first location thereof in which the slats are disposed in the open disposition thereof to a lowered second location of the valance when the slats are disposed in the closed disposition thereof. The arrangement is such that the tilting mechanism is hidden from view when the slats are disposed in the open and closed dispositions.

In one embodiment of the present invention, the valance is secured to the first control such that movement of the first control slides the valance between the first and second locations thereof.

However, in a second embodiment of the present invention, the valance is secured to the tilting mechanism such that movement of the tilting mechanism slides the valance between the first and second locations thereof.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of a control apparatus according to the present invention for controlling tilting of a plurality of horizontally disposed mini-blind slats;

FIG. 2 is an enlarged fragmentary sectional view taken on the line 2-2 of FIG. 1;

FIG. 3 is a similar view to that shown in FIG. 2 but shows the slats in a closed disposition thereof;

FIG. 4 is a fragmentary perspective view of the tilting mechanism shown in FIGS. 2 and 3;

FIG. 5 is a perspective view of the spool and the further control of the present invention;

FIG. 6 is an enlarged fragmentary sectional view of the tilting mechanism shown in FIG. 2;

FIG. 7 is a similar view to that shown in FIG. 6 but shows the slats in the closed disposition thereof and the valance secured to the first control and in the second location thereof;

FIG. 8 is a sectional view similar to that shown in FIG. 6 but viewed from the opposite side showing a further embodiment of the present invention; and

FIG. 9 is a similar view to that shown in FIG. 8 but shows the controls having been moved by the tilting mechanism so that the slats are disposed in the closed disposition.

Similar reference characters refer to similar parts throughout the various views of the drawings.

### DETAILED DESCRIPTION OF THE DRAWINGS

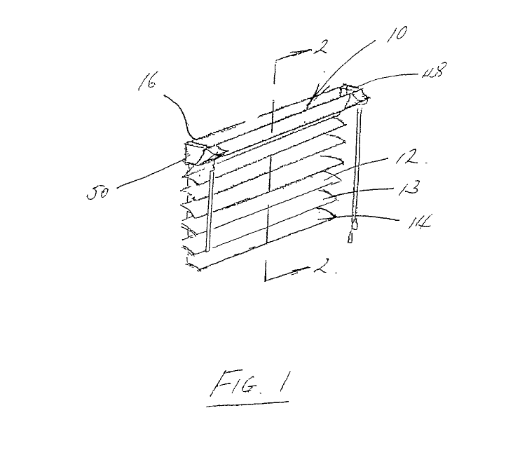

FIG. 1 is a perspective view of a control apparatus generally designated 10 according to the present invention, for controlling tilting of a plurality of horizontally disposed mini-blind slats 12, 13 and 14 respectively. The apparatus 10 includes a support frame 16 for supporting the plurality of slats 12-14 such that the slats 12-14 are disposed spaced and parallel relative to each other.

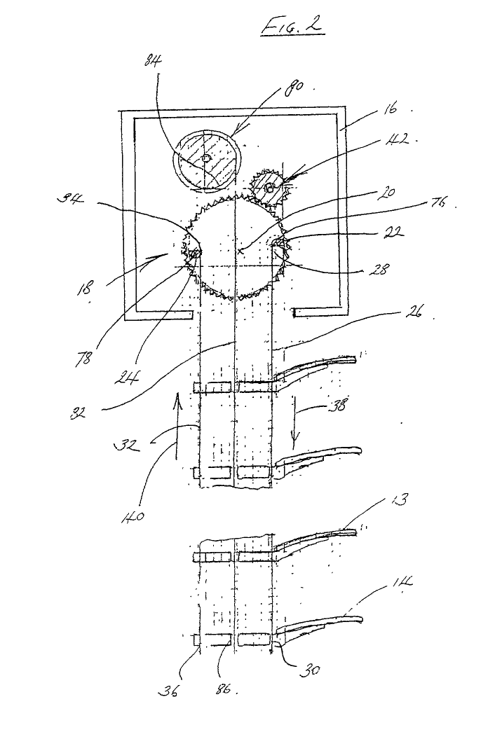

FIG. 2 is an enlarged fragmentary sectional view taken on the line 2-2 of FIG. 1. As shown in FIG. 2 a tilting mechanism generally designated 18 is pivotally secured to the frame 16 about a pivotal axis 20 which extends spaced and parallel relative to the slats 12-14. A first anchor 22 is secured to the tilting mechanism 18 and a second anchor 24 is secured to the tilting mechanism 18 such that the pivotal axis 20 of the tilting mechanism 18 is disposed between the first and second anchors 22 and 24 respectively. A first control 26 has a first and a second end 28 and 30 respectively, the first end 28 of the first control 26 being secured to the first anchor 22. A second control 32 has a first and a second extremity 34 and 36 respectively, the first extremity 34 of the second control 32 being secured to the second anchor 24. The first and second controls 26 and 32 respectively are connected to the slats 12-14 such that relative movement as indicated by the arrows 38 and 40 between the first and second control 26 and 32 respectively tilts the slats between an open disposition as shown in FIG. 2 and a closed disposition thereof. A device generally designated 42 is drivingly connected to the tilting mechanism 18 for pivoting the tilting mechanism 18 about the pivotal axis 20 so that the slats 12-14 are tilted between the open and closed dispositions.

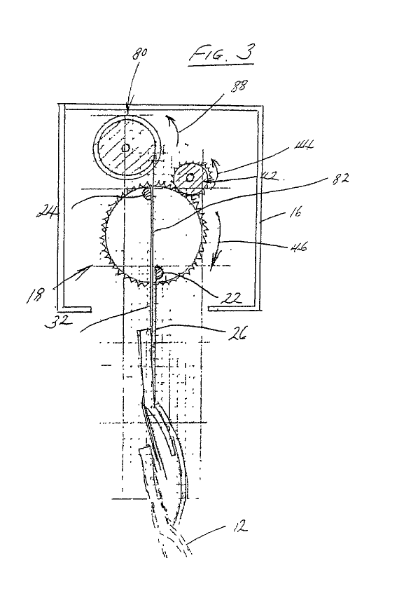

FIG. 3. is a similar view to that shown in FIG. 2 but shows the slats 12-14 in a closed disposition thereof. As shown in FIG. 3, the device 42 has been rotated in the direction indicated by arrow 44 and the tilting mechanism 18 is driven by the device 42 as indicated by the arrow 46 for tilting the slats 12-14. Also, the support frame as shown in FIGS. 2 and 3 is of inverted U-shaped cross-sectional configuration, the frame 16 having a first and a second side 48 and 50 as shown in FIG. 1.

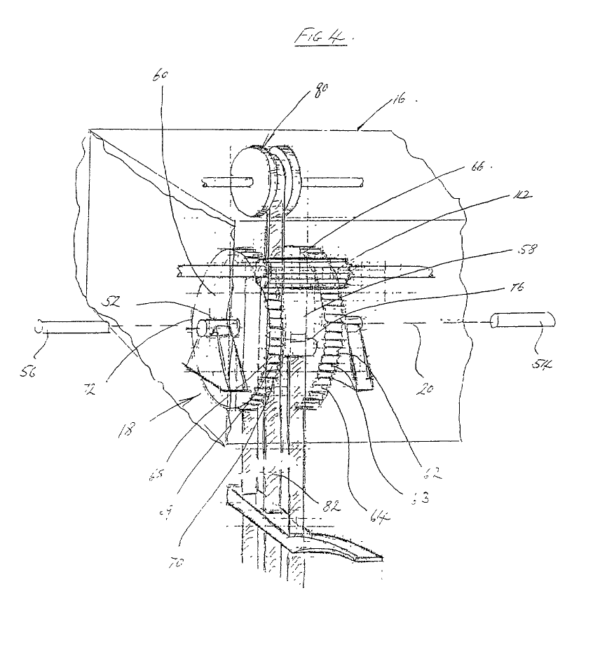

FIG. 4 is a fragmentary perspective view of the tilting mechanism 18 shown in FIGS. 2 and 3. As shown in FIG. 4, the tilting mechanism 18 includes an axle 52 having a first and a second termination 54 and 56, the axle 52 being rotatable about the pivotal axis 20. Also, the axle 52 is secured to and disposed within the frame 16 such that pivoting of the tilting mechanism 18 about the pivotal axis 20 is permitted.

Additionally, the tilting mechanism 18 includes a first and a second wheel 58 and 60 respectively, the wheels 58 and 60 being congruent and spaced relative to each other.

Furthermore, the first wheel 58 defines a plurality of teeth 62, 63 and 64 which extend around at least a portion of a periphery 66 of the first wheel 58. Also, the second wheel 60 defines a further plurality of teeth 68, 69 and 70 which extend around at least a portion of a periphery 72 of the second wheel 60 so that when at least one of the wheels 58 and 60 is driven via the teeth 62-64 and 68-70, the tilting mechanism 18 is pivoted about the pivotal axis 20.

More specifically, the first anchor 22 defines a slot 76 for anchoring the first end 28 of the first control 26 as shown in FIGS. 2 and 4. Additionally, the second anchor 24 defines a further slot 78 shown in FIG. 2, for anchoring the first extremity 34 of the second control 32, the anchors 22 and 24 being secured to and extending between the first and second wheels 58 and 60 as shown in FIG. 4.

The first control 26 is a polyester tape and the second control 32 is also a polyester tape.

More particularly, the polyester tapes 26 and 32 are of rectangular cross sectional configuration and are fabricated from a translucent material.

The first control 26 is connected to the slats 12-14 between the first and second ends 28 and 30 of the first control 26 and the second control 32 is connected to the slats 12-14 between the first and second extremities 34 and 36 of the second control 32.

Additionally, the device 42 as shown in FIGS. 2-4 drivingly intermeshes with the plurality of teeth 62-64 and the further plurality of teeth 68-70 so that when the device 42 is rotated as indicated by the arrow 44 shown in FIG. 3, the wheels 58 and 60 are pivoted about the pivotal axis 20.

As shown in FIGS. 2-4, the apparatus 10 also includes a spool 80 which is rotatably secured to the frame 16 such that the tilting mechanism 18 is disposed between the spool 80 and the slats 12-14.

A further control 82 has a first and a second termination 84 and 86 respectively, the first termination 84 being anchored to the spool 80 so that when the spool 80 is rotated as indicated by the arrow 88 shown in FIG. 3, the further control 82 is wound around the spool 80.

The second termination 86 of the further control 82 is secured to a lowermost slat 14 of the plurality of slats 12-14 as shown in FIG. 2, the further control 82 being slidably connected to the slats 12-13 disposed between the lowermost slat 14 and the tilting mechanism 18. The arrangement is such that the further control 82 extends between the wheels 58 and 60 of the tilting mechanism 18 as shown in FIG. 4, so that when the spool 80 is rotated as indicated by the arrow 88, the lowermost slat 14 is lifted into lifting engagement with the slats 13 and 12 disposed between the lowermost slat 14 and the tilting mechanism 18 such that the slats 12-14 are raised towards the frame 16.

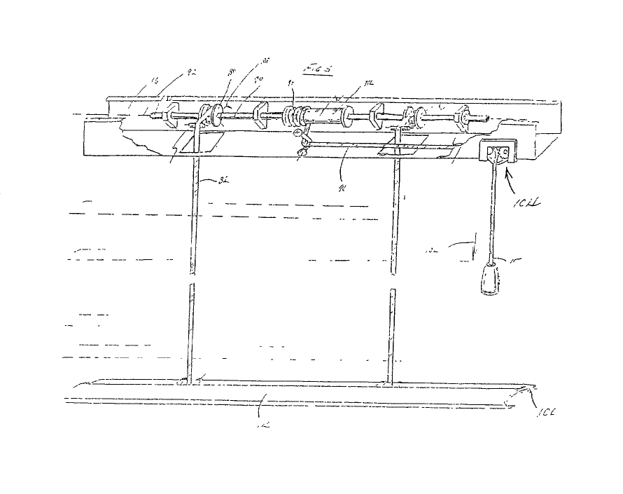

FIG. 5 is a perspective view of the spool 80 and the further control 82. As shown in FIG. 5, a shaft 90 is rotatably secured to the frame 16, the shaft 90 being secured to the spool 80 such that when the shaft 90 is rotated as indicated by the arrow 88, about a further pivotal axis 92 , the spool 80 is rotated for winding and unwinding the further control 82.

A driving drum 94 is secured to the shaft 90 and is spaced axially relative to the spool 80. Also, a flexible drive 96 such as a cord, has a first and a second end 98 and 100. The first end 98 of the flexible drive 96 is anchored to the driving drum 94 such that when the second end 100 of the flexible drive 96 is pulled as indicated by the arrow 102, the flexible drive 96 is unwound from the driving drum 94 so that the driving drum 94 is rotated as indicated by the arrow 88 for rotating the spool 80 for lifting the slats 12-14.

Additionally, a locking mechanism generally designated 104 is provided for locking the flexible drive 96 so that the lowermost slat 14 is able to be selectively located relative to the frame 16.

A weight 106 is secured to at least one of the slats 12-14 for assisting lowering the lowermost slat 14 away from the frame 16 when the locking mechanism 104 is disengaged from the flexible drive 96.

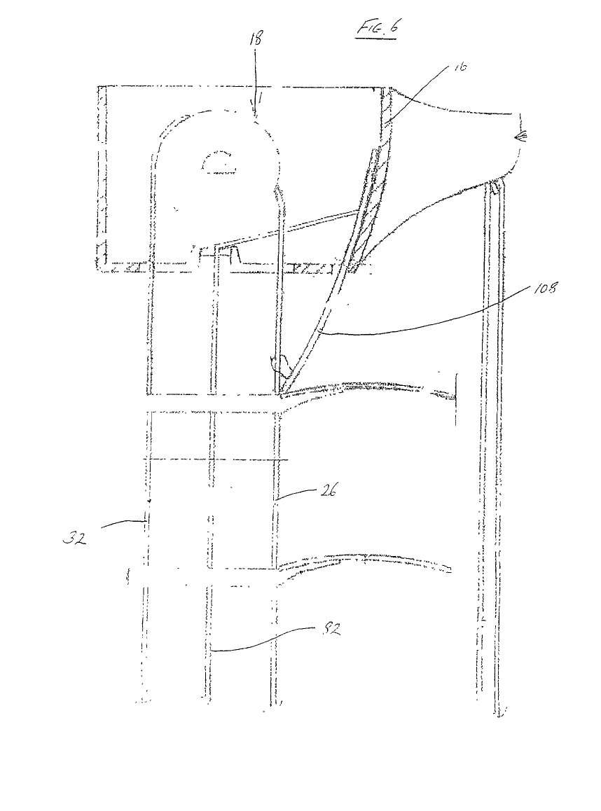

FIG. 6 is an enlarged fragmentary sectional view of the tilting mechanism 18. As shown in FIG. 6, the apparatus 10 further includes a valance 108 which is slidably disposed relative to the frame 16. The valance 108 slides from a first location thereof as shown in FIG. 6 in which the slats 12-14 are disposed in the open disposition thereof to a lowered second location of the valance 108 when the slats 12-14 are disposed in the closed disposition thereof.

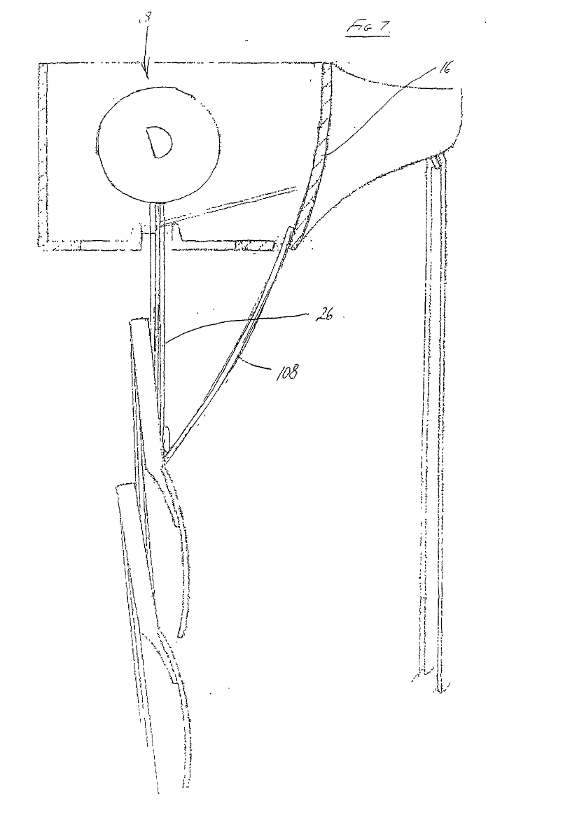

FIG. 7 is a similar view to that shown in FIG. 6 but shows the slats 12-14 in the closed disposition thereof and the valance 108 secured to the control 26 and in the second location. The arrangement is such that the tilting mechanism 18 is hidden from view when the slats 12-14 are disposed in the open and closed dispositions as shown in FIGS. 6 and 7 respectively.

In one embodiment of the present invention as shown in FIGS. 6 and 7, the valance 108 is secured to the first control 26 such that movement of the first control 26 slides the valance 108 between the first and second locations thereof as shown in FIGS. 6 and 7 respectively.

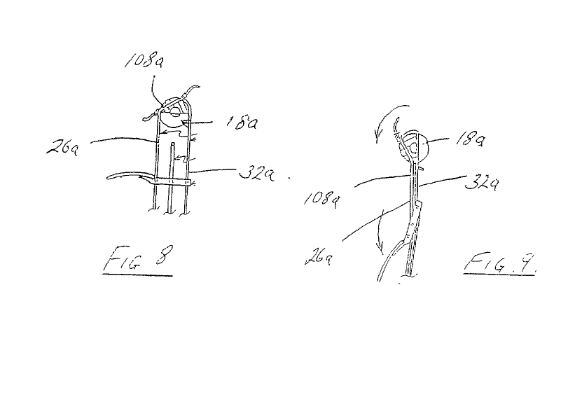

FIG. 8 is a sectional view similar to that shown in FIG. 6 but viewed from the opposite side showing a further embodiment of the present invention. As shown in FIG. 8, the valance 108a is secured to the tilting mechanism 18a such that movement of the tilting mechanism 18a moves the valance 108a between the first and second locations thereof.

FIG. 9 is a similar view to that shown in FIG. 8 but shows the controls 26a and 32a having been moved by the tilting mechanism 18a so that the slats are disposed in the closed disposition. Also, movement of the tilting mechanism 18a moves or rotates the valance 108a to the second lowered location for blocking the tilting mechanism 18a from view.

In operation of the apparatus according to the present invention, when the device 42 is rotated by means well known in the art, the wheels 58 and 60 are rotated so that the controls 26 and 32 are moved relative to each other for tilting the slats 12-14.

Additionally, when the flexible drive 96 is pulled as indicated by arrow 102 of FIG. 5, the driving drum 94 is rotated thus rotating the spool 80 for winding the further control 82 for lifting the slats 12-14.

Furthermore, when the slats are moved from the open to the closed dispositions thereof as shown respectively in FIGS. 6 and 7, the valance 108 is lowered so that the tilting mechanism is screened from view.

The present invention provides a unique apparatus for controlling tilting and lifting mini-blind slats.

What is claimed is:

1. A control apparatus for controlling tilting of a plurality of horizontally disposed mini-blind slats, said apparatus comprising:
a support frame for supporting the plurality of slats such that the slats are disposed spaced and parallel relative to each other;
a tilting mechanism pivotally secured to said frame about a pivotal axis which extends spaced and parallel relative to the slats;
a first anchor secured to said tilting mechanism;
a second anchor secured to said tilting mechanism such that said pivotal axis of said tilting mechanism is disposed between said first and second anchors;
a first control having a first and a second end, said first end of said first control being secured to said first anchor;
a second control having a first and a second extremity, said first extremity of said second control being secured to said second anchor;
said first and second controls being connected to the slats such that relative movement between said first and second control tilts the slats between an open and a closed disposition thereof; and
a device drivingly connected to said tilting mechanism for pivoting said tilting mechanism about said pivotal axis so that the slats are tilted between said open and closed dispositions.

2. A control apparatus as set forth in claim 1 wherein
said support frame is of inverted U-shaped cross-sectional configuration, said frame having a first and a second side.

3. A control apparatus as set forth in claim 1 wherein
said tilting mechanism includes:
an axle having a first and a second termination, said axle being rotatable about said pivotal axis, said axle being secured to and disposed within said frame such that pivoting of said tilting mechanism about said pivotal axis is permitted.

4. A control apparatus as set forth in claim 1 wherein
said tilting mechanism includes:
a first and a second wheel, said wheels being congruent and spaced relative to each other.

5. A control apparatus as set forth in claim 4 wherein
said first wheel defines a plurality of teeth which extend around at least a portion of a periphery of said first wheel;
said second wheel defines a further plurality of teeth which extend around at least a portion of a periphery of said second wheel so that when at least one of said wheels is driven via said teeth, said tilting mechanism is pivoted about said pivotal axis.

6. A control apparatus as set forth in claim 4 wherein
said first anchor defines a slot for anchoring said first end of said first control; said second anchor defining a further slot for anchoring said first extremity of said second control, said anchors being secured to and extending between said first and second wheels.

7. A control apparatus as set forth in claim 1 wherein
said first control is a polyester tape;
said second control is a polyester tape.

8. A control apparatus as set forth in claim 7 wherein
said polyester tapes are of rectangular cross sectional configuration.

9. A control apparatus as set forth in claim 7 wherein
said polyester tapes are translucent.

10. A control apparatus as set forth in claim 1 wherein
said first control is connected to the slats between said first and second ends of said first control;
said second control is connected to the slats between said first and second extremities of said second control.

11. A control apparatus as set forth in claim 5 wherein
said device drivingly intermeshes with said plurality of teeth and said further plurality of teeth so that when said device is rotated, said wheels are pivoted about said pivotal axis.

12. A control apparatus as set forth in claim 4 further including:
a spool rotatably secured to said frame such that said tilting mechanism is disposed between said spool and the slats;
a further control having a first and a second termination, said first termination being anchored to said spool so that when said spool is rotated, said further control is wound around said spool;
said second termination of said further control being secured to a lowermost slat of the plurality of slats, said further control being slidably connected to the slats disposed between the lowermost slat and said tilting mechanism so that said further control extends between said wheels of said tilting mechanism, the arrangement being such that when said spool is rotated, said lowermost slat is lifted into lifting engagement with the slats disposed between the lowermost slat and said tilting mechanism so that the slats are raised towards said frame.

13. A control apparatus as set forth in claim 12 further including:
a shaft rotatably secured to said frame, said shaft being secured to said spool such that when said shaft is rotated about a further pivotal axis, said spool is rotated for winding and unwinding said further control;
a driving drum secured to said shaft and spaced axially relative to said spool;
a flexible drive having a first and a second end, said first end of said flexible drive being anchored to said driving drum such that when said second end of said flexible drive is pulled, said flexible drive is unwound from said driving drum so that said driving drum is rotated for rotating said spool for lifting the slats.

14. A control apparatus as set forth in claim 13 further including:
a locking mechanism for locking said flexible drive so that said lowermost slat is able to be selectively located relative to said frame;
a weight secured to at least one of the slats for assisting lowering said lowermost slat away from said frame when said locking mechanism is disengaged from said flexible drive.

15. A control apparatus as set forth in claim 1 further including:
a valance slidably disposed relative to said frame, said valance sliding from a first location thereof in which the slats are disposed in said open disposition thereof to a lowered second location of said valance when the slats are disposed in said closed disposition thereof, so that said tilting mechanism is hidden from view when the slats are disposed in said open and closed dispositions.

16. A control apparatus as set forth in claim 15 wherein
said valance is secured to said first control such that movement of said first control slides said valance between said first and second locations thereof.

17. A control apparatus as set forth in claim 15 wherein
said valance is secured to said tilting mechanism such that movement of said tilting mechanism slides said valance between said first and second locations thereof.

18. A control apparatus for controlling tilting of a plurality of horizontally disposed mini-blind slats, said apparatus comprising:
a support frame for supporting the plurality of slats such that the slats are disposed spaced and parallel relative to each other;
a tilting mechanism pivotally secured to said frame about a pivotal axis which extends spaced and parallel relative to the slats;
a first anchor secured to said tilting mechanism;
a second anchor secured to said tilting mechanism such that said pivotal axis of said tilting mechanism is disposed between said first and second anchors;
a first control having a first and a second end, said first end of said first control being secured to said first anchor;
a second control having a first and a second extremity, said first extremity of said second control being secured to said second anchor;
said first and second controls being connected to the slats such that relative movement between said first and second control tilts the slats between an open and a closed disposition thereof;
a device drivingly connected to said tilting mechanism for pivoting said tilting mechanism about said pivotal axis so that the slats are tilted between said open and closed dispositions;
a spool rotatably secured to said frame such that said tilting mechanism is disposed between said spool and the slats;
a further control having a first and a second termination, said first termination being anchored to said spool so that when said spool is rotated, said further control is wound around said spool; and
said second termination of said further control being secured to a lowermost slat of the plurality of slats, said further control being slidably connected to the slats disposed between the lowermost slat and said tilting mechanism so that said further control extends through said tilting mechanism, the arrangement being such that when said spool is rotated, said lowermost slat is lifted into lifting engagement with the slats disposed between the lowermost slat and said tilting mechanism so that the slats are raised towards said frame.

19. A control apparatus for controlling tilting of a plurality of horizontally disposed mini-blind slats, said apparatus comprising:
a support frame for supporting the plurality of slats such that the slats are disposed spaced and parallel relative to each other;
a tilting mechanism pivotally secured to said frame about a pivotal axis which extends spaced and parallel relative to the slats;
a first anchor secured to said tilting mechanism;
a second anchor secured to said tilting mechanism such that said pivotal axis of said tilting mechanism is disposed between said first and second anchors;
a first control having a first and a second end, said first end of said first control being secured to said first anchor;
a second control having a first and a second extremity, said first extremity of said second control being secured to said second anchor;
said first and second controls being connected to the slats such that relative movement between said first and second control tilts the slats between an open and a closed disposition thereof;
a device drivingly connected to said tilting mechanism for pivoting said tilting mechanism about said pivotal axis so that the slats are tilted between said open and closed dispositions; and
a valance slidably disposed relative to said frame, said valance sliding from a first location thereof in which the slats are disposed in said open disposition thereof to a lowered second location of said valance when the slats are disposed in said closed disposition thereof, so that said tilting mechanism is hidden from view when the slats are disposed in said open and closed dispositions.
